(19) United States
(12) Patent Application Publication
(10) Pub. No.: US 2005/0268907 A1
(43) Pub. Date: Dec. 8, 2005

(54) Integrated respirator

(75) Inventor: Robert McFarlane, Lochwinnoch, Renfrewshire (GB)

Correspondence Address: CROWELL & MORING LLP;INTELLECTUAL PROPERTY GROUP, P.O. BOX 14300, WASHINGTON, DC, 20044-4300, US

(73) Assignee: BAE Systems plc, London (GB)

(21) Appl. No.: 10/528,066

(22) PCT Filed: Oct. 20, 2003
(86) PCT No.: PCT/GB03/04520

§ 371 Date: Mar. 15, 2005

(30) Foreign Application Priority Data
Oct. 18, 2002 (GB) 0224293.1
Jan. 8, 2003 (GB) 0300365.4

(51) Int. Cl. A62B 17/04; A62B 18/00

(52) U.S. Cl. 128/201.22; 128/201.24; 128/201.25

(57) ABSTRACT

An integrated respirator comprises a rigid helmet and a flexible cowl having an airtight neck seal. When deployed by a user the integrated respirator provides a barrier for nuclear, biological and chemical hazards while maintaining a high level of comfort and user acceptability since it is designed to avoid direct contact of the flexible cowl with the user's head. The respirator is designed with an innate flexibility, which it to be adjusted so as to improve user comfort while also permitting the same design to be employed by different users.

This invention relates to a respirator. In particular it relates to an integrated respirator that is suitable for use by aircrew so as to provide significant higher levels of comfort, stability and user acceptability.

Aircrew can be exposed to nuclear, biological and chemical (NBC) hazards in the course of their flying duties. Therefore, in order to negate the effects of such NBC hazards any respiratory system as well as the crews eyes must be protected against aerosols and gases in the air. Additionally, the rest of the body of any crew member must be protected against direct contact with NBC agents in the form of liquid or solid particles.

Protection of respiratory systems, eyes and skin area above the neck of aircrew is normally achieved by wearing an integrated respirator. Typical integrated respirator known to those skilled in the art consists of, but are not exclusively limited to, a head cowl or hood, an oxygen mask, a breathing gas supply hose, a clear visor, a neck seal and a shoulder cover that forms a leak-proof assembly that fully encloses the head.

Such respirators are specifically designed to either fit over or under the users flying helmet. Such designs have a number of inherent problematic features. In particular the over the helmet designs are bulky, and are easily ruptured in wind blast and ejection forces exhibited during emergency egress. Furthermore, it is difficult to interface the over the helmet designs with other equipment that requires to be mounted with the users flying helmet.

For these reasons the under helmet configuration has been adopted by most aircrew. There are two main types of under helmet respirator known in the art. The first type is worn under the helmet assembly and forms a close fitting hood around the head with an integral visor aperture and oxygen mask. This respirator type has several deficiencies the principal being that most users experience feelings of isolation or, semi-claustrophobia, and heat stress attributed to the hood hugging the head and being held firmly in place by the helmet.

A second limitation of this type of respirator is the associated reduced sound attenuation performance of the ear cup. This is due to the respirator cowl fitting between the ear and the ear cup.

A further deficiency of these respirators is the fact that the material used for the hood must stretch for donning and doffing. Thereafter, the material must conform to the profile of the user's head so as to provide a suitable mounting surface for the helmet. Bromo butyl rubber is an example of an elastic material used in the manufacture of cowls for such respirators. However, this material produces high levels of discomfort when worn next to the skin while reducing the stability of the helmet.

Head mounted respirators with potentially lower levels of discomfort are also available. However, the materials used to construct such respirators do not stretch and as such the cowl shape is required to be manufactured from several shaped sections that are stitched and/or bonded together. As a result these respirator designs are particularly prone to leakage through the stitched and bonded seams.

Another type of under helmet respirator known to those skilled in the art employs comfort padding and communication system ear cups on the inside surface of the cowl. This arrangement allows air movement inside the cowl reducing the thermal stress. In addition, as the ear cups are in direct contact with the head this results in improved levels of sound attenuation. The major disadvantages of this type of respirator is the difficulty experienced in getting the ear cups correctly positioned inside the cowl and the requirement for an increased number of leak proof feed through apertures such as ear cup cableforms and comfort pad to suspension system fastenings. This results in unacceptable donning times and an increased potential for faults leading to leakage.

It is an object of an aspect of the present invention to provide an integrated respirator that provides a high level of comfort, helmet stability and user acceptability by being designed and constructed so as to reduce direct contact with a user's head so rendering the resprator easy for a user to don and doff.

According to a first aspect of the present invention there is provided an integrated respirator that provides an airtight barrier for a user's head comprising a first rigid helmet and a flexible cowl having an airtight neck seal, wherein the first rigid helmet defines an access aperture suitable for locating directly on a user's head and the flexible cowl is sealably fixed to the first rigid helmet so providing a physical barrier for the access aperture while forming an airtight seal with a user's neck.

Most preferably the first rigid helmet and the flexible cowl comprises material that protects against nuclear, chemical and biological hazards.

Preferably the flexible cowl completely encloses the first rigid helmet. Alternatively, the flexible cowl is connected to the periphery of the access aperture. In a further alternative the flexible cowl connects to an inner surface of the first rigid helmet.

Most preferably the first rigid helmet provides a tight fit with the user's head.

Optionally the integrated respirator further comprises a hood that is fixed to the first rigid helmet so providing a physical barrier for the flexible cowl thus improving the fire proof, snag proof and windblast proof properties of the integrated respirator.

Preferably the flexible cowl comprises a visor aperture, an oxygen mask location area, a visor mist air supply and a pressure release valve.

Preferably the integrated respirator further comprises a second rigid helmet suitable for locating over the first rigid helmet, an oxygen mask and a first visor.

Preferably the oxygen mask location area comprises a plurality of apertures suitable for receiving one or more component parts of the oxygen mask when the oxygen mask is located within the oxygen mask location area. Alternatively, the oxygen mask location area comprises a single aperture suitable for receiving the oxygen mask.

Most preferably the oxygen mask comprises a coating that provides a barrier for nuclear, biological and chemical hazards.

Most preferably the oxygen mask provides an air tight seal about the user's nose and mouth.

Optionally the flexible cowl further comprises a detachable front face connected to the flexible cowl by a first airtight seal.

Preferably the first airtight seal comprises a beading edge associated with the detachable front face, a channel associated with the flexible cowl and suitable for receiving the beading edge and a zip mechanism suitable for opening and sealing the first airtight seal.

Optionally the flexible cowl comprises attachment point access holes and compression seals.

Optionally the flexible cowl further comprises a head cowl and a detachable lower section wherein the head cowl and detachable lower section are connected by a second airtight seal.

Preferably the second airtight seal comprises a beading edge associated with the head cowl, a channel associated with the detachable lower section and suitable for receiving the beading edge and a zip mechanism suitable for opening and sealing the second airtight seal.

Preferably the first rigid helmet further comprises an energy absorbing liner, attachment points suitable for threading through the attachment point access holes such that the first rigid helmet can be connected to the second rigid helmet.

Preferably the first rigid helmet further comprises ear phones and at least one earphone aperture associated with each earphone.

Preferably the first rigid helmet further comprises attachment means suitable for connecting oxygen mask mounting means of the oxygen mask to the first rigid helmet.

Optionally the first rigid helmet comprises a retractable earphone mount wherein the retractable earphone mount comprises a bias means that acts to maintain an associated earphone in a first position and a retracting means suitable for overcoming the bias means such that the associated earphone is moved to a second retracted position suitable for aiding the donning and doffing of the integrated respirator.

Preferably the retracting means comprises a draw string threaded through an aperture in the first rigid helmet. Optionally the first rigid helmet further comprises a securing means to which the draw string can be attached so as to maintain the retractable earphone mount in the second retracted position.

Most preferably the first visor locates within the first visor aperture so providing a visor airtight seal with the flexible cowl.

Optionally the visor airtight seal provides means for adjustment of the position of the first visor relative to the rigid helmet.

Preferably the means for adjustment allows the visor to move to a displaced position suitable for aiding the donning and doffing of the integrated respirator.

Optionally the second rigid helmet further comprises a second visor.

Preferably the first and second visors comprise a high optical quality material that provides a barrier for nuclear, biological and chemical hazards.

According to a second aspect of the present invention there is provided a method of fabricating an integrated respirator in accordance with the first aspect of the present invention comprising:
1) Fabricating a flexible cowl;
2) Forming an oxygen mask location area and a visor aperture in the flexible cowl;
3) Locating a visor within the visor aperture so as to form an airtight seal between the visor and the flexible cowl;
4) Locating an oxygen mask within the oxygen mask suspension system aperture so as to form an airtight seal between the oxygen mask and the flexible cowl; and
5) Attaching the flexible cowl to a first rigid helmet so as to form an airtight seal between the first rigid helmet and the flexible cowl.

Preferably location points on the helmet ensure that the flexible cowl is correctly located on the first rigid helmet and provide means for connecting the first rigid helmet to a second rigid helmet.

Most preferably the flexible cowl is fabricated by:
1) Vacuum forming a flexible material and fixing the vacuum formed material by seam welding;
2) Fabricating an airtight neck seal and attaching said neck seal to the vacuum formed material;
   preferably the step of fabricating the flexible cowl further comprises the steps of:
1) Connecting a visor mist air supply to the vacuum formed material; and
2) Connecting a pressure release valve to the vacuum formed material.

Preferably the visor is injection moulded from a material of high optical coating. Thereafter the outer surface of the visor is coated with a nuclear, biological and chemical resistant coating. Optionally the inner surface of the visor is coated with an anti fogging coating.

Embodiments of the invention wall now be described, by way of example only, with reference to the accompanying drawings, in which:

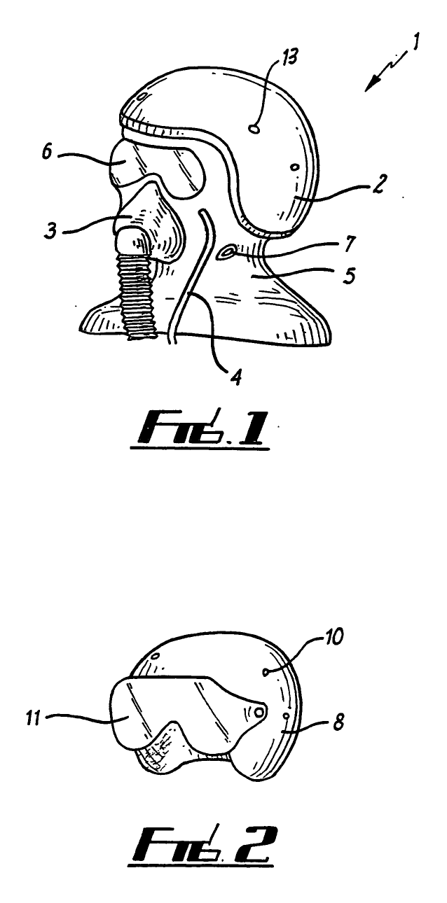

FIG. 1 present a schematic representation of an integrated respirator in the absence of an outer helmet in accordance with an aspect of the present invention;

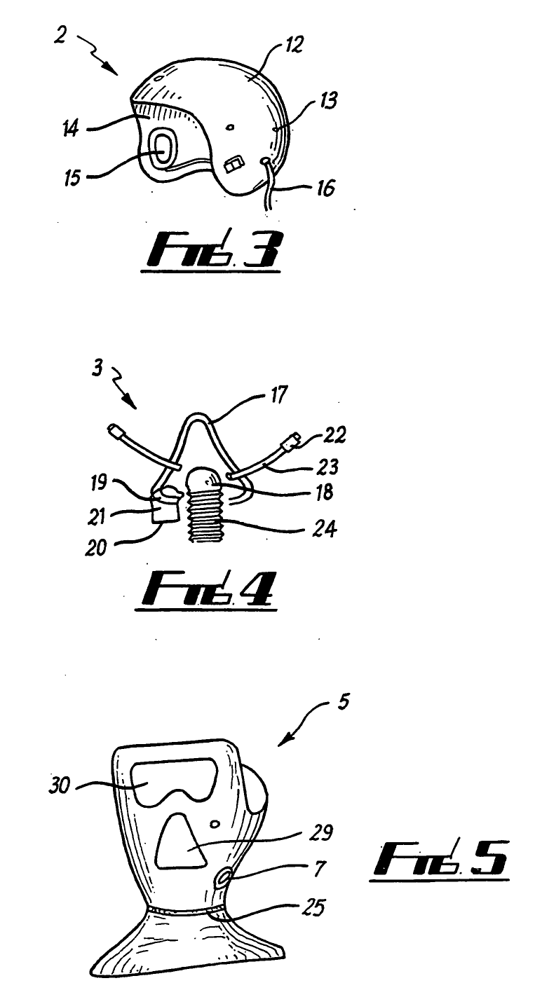

FIG. 2 present a schematic representation of the outer helmet suitable for use with the integrated respirator of FIG. 1;

FIG. 3 presents detail of an inner helmet of the integrated respirator of FIG. 1;

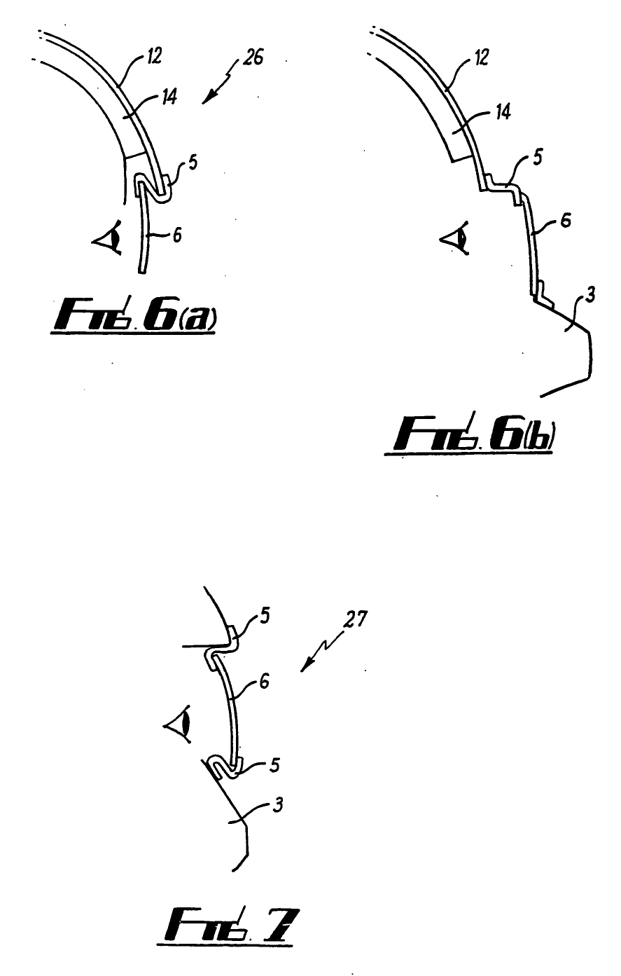

FIG. 4 presents detail of an oxygen mask of the integrated respirator of FIG. 1;

FIG. 5 presents detail of a flexible cowl of the integrated respirator of FIG. 1;

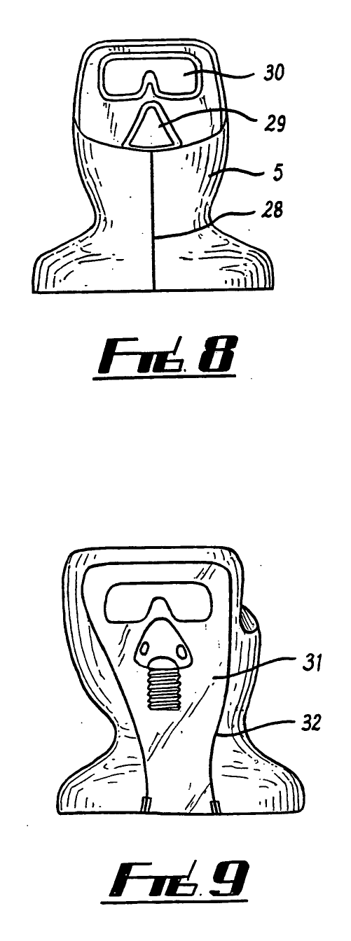

FIG. 6 presents detail of a connection means for a visor and the flexible cowl of FIG. 5:

(a) when the visor is positioned over a user's eyes; and

(b) when the visor is in a displaced position suitable for donning and doffing the integrated respirator;

FIG. 7 presents detail of an alternative embodiment connection means for the visor and the flexible cowl of FIG. 5;

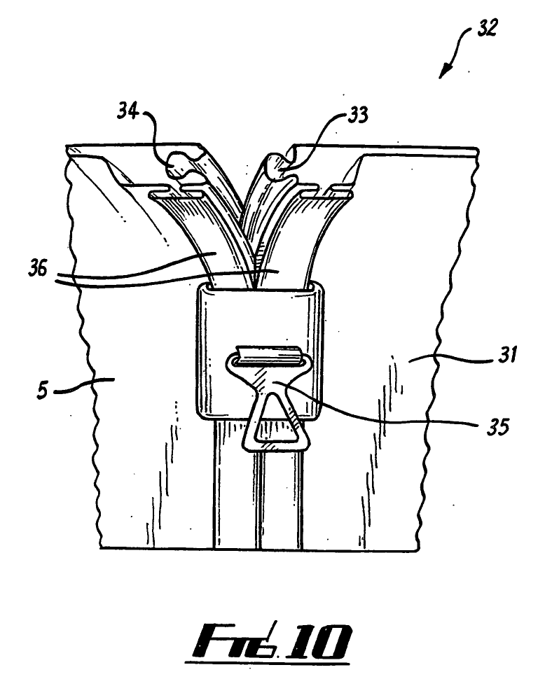

FIG. 8 illustrates the formation of the integrated respirator by employing a vacuum forming method;

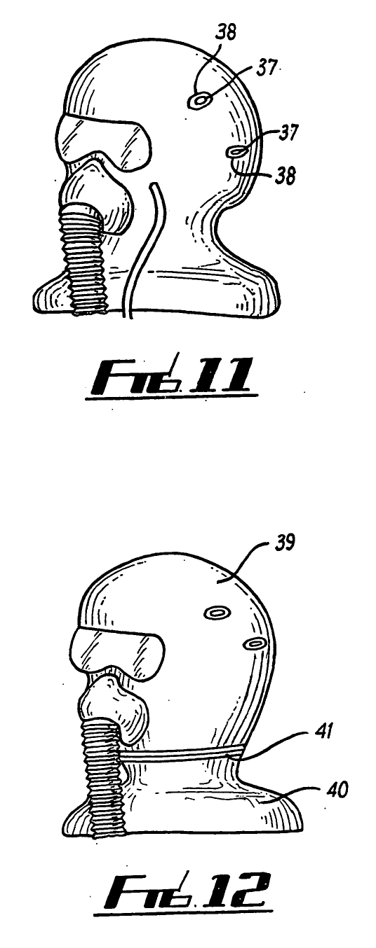

FIG. 9 presents an alternative embodiment of the integrated respirator in accordance with aspects of the present invention;

FIG. 10 presents detail of an attachment means of the integrated respirator of FIG. 9;

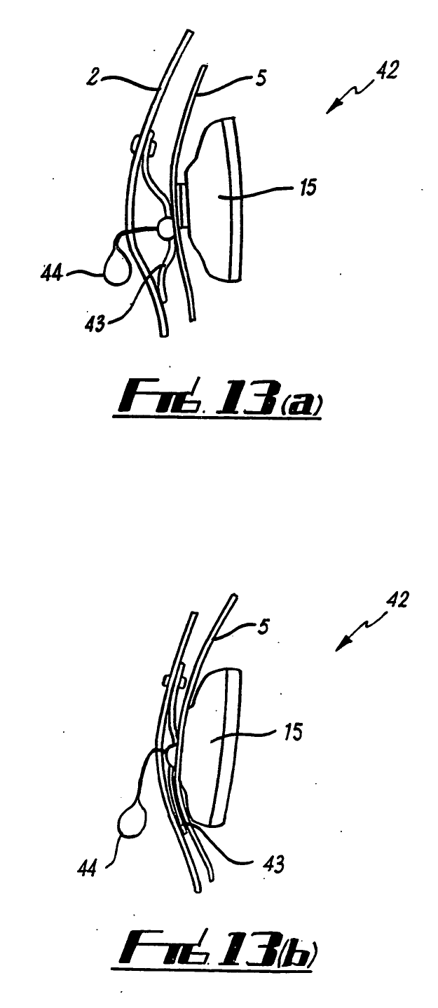

FIG. 11 presents a further alternative embodiment of the integrated respirator in accordance with aspects of the present invention; and

FIG. 12 presents a yet further alternative embodiment of the integrated respirator in accordance with aspects of the present invention;

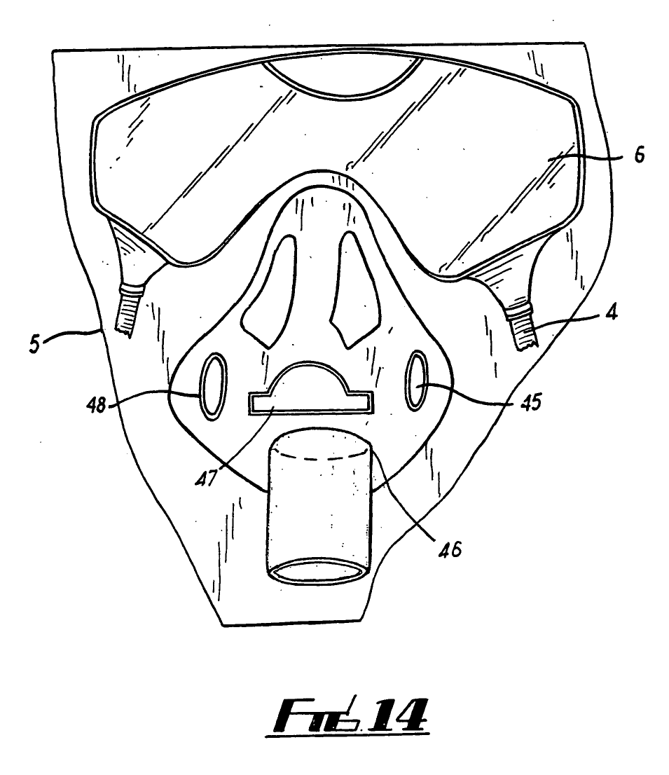

FIG. 13 presents detail of a connection means for an earphone and a flexible cowl of the integrated respirators of FIG. 11 and 12:

(a) when the earphone is positioned over a user's ear; and

(b) when the earphone is in a displaced position suitable for donning and doffing the integrated respirator.

FIG. 14 presents an alternative embodiment for the incorporation of the oxygen mask and the flexible cowl.

FIG. 1 presents an integrated respirator 1 in accordance with an aspect of the present invention. The integrated respirator 1 can be seen to comprise an inner helmet 2, an oxygen mask suspension system 3, a visor demist air supply 4, a flexible cowl 5 on which is mounted a first visor 6 and a non-return exhaust valve 7.

The first visor 6 shown in FIG. 1 is manufactured from a high optical quality material and is bonded or welded to the flexible cowl 5. NBC hazards when deposited on the visor would attack the surface of conventional polycarbonate visors therefore, to protect the visor a NBC resistant coating is applied to the outer surface.

The inner surface is also be coated with an anti fogging coating.

The visor demist air supply 4 also helps to prevent the misting of the visor by supplying a flow of air that is directed over the visor. The air, in normal mode, is exhausted from the flexible cowl 5 through the non-return exhaust valve 7 such that a positive pressure is maintained within the cowl.

FIG. 2 presents an outer helmet 8 suitable for use with the integrated respirator 1. The outer helmet 8 comprises an outer shell 9 on which are located outer to inner helmet attachment points 10 and a detachable second visor 11.

Details of the inner helmet 2, the oxygen mask 3 and the flexible cowl 5 are presented in FIGS. 3, 4 and 5 respectively. The inner helmet 2 comprises an NBC resistant shell 12 with attachment points 13 for both the outer helmet 8 and oxygen mask suspension system 3. The inner helmet 2 is lined with impact absorbing liners 14 and earphones 15 and earphone cabling 16 are attached to the inner surface.

The oxygen mask suspension system 3, shown in FIG. 4 comprises a face seal 17 that acts to isolate the mask oro-nasal breathing cavity from the flexible cowl 5 and the first visor 6. Therefore, the face seal 17 helps prevent misting of the first visor 6 by exhaled gases from the user. Breathing gas is supplied to the user by inhalation through a non-return inspiratory valve 18. On being exhaled the gas exits the oxygen mask suspension system 3 through a first non-return expiratory valve 19.

To prevent any reverse gas flow into the oxygen mask suspension system 3 a second non-return valve 20 is fitted in series with the first 19 so as to create an isolating chamber 21.

An examination of FIG. 4 shows that the oxygen mask suspension system 3 further comprises two mask mounting means 22, two mask retention assemblies 23 and a gas supply hose 24. The combination of the mask mounting means 22 and the mask retention assemblies 23 allow the oxygen mask suspension system 3 to be directly connected to the inner helmet therefore helping to maintain the air tight seal between the face seal 17 and the flexible cowl 5.

The gas supply hose 24 comprises a flexible pipe that is resistant to penetration by NBC contaminants. The hose 24 is connected at one end to the face seal 17 while the other end is coupled to a supply of filtered air or oxygen from an aircraft oxygen generator. The gas supply hose 24 can also be coupled to a portable air supply for transit to and from an aircraft.

The flexible cowl 5 shown in FIG. 5 specifically covers the portion of the head and neck of the user that is not protected by the inner helmet 2 and any NBC clothing worn by the user. A neck seal 25 provides the required airtight seal between the flexible cowl and the user's neck.

The oxygen mask suspension system 3 and the first visor 6 are attached to the flexible cowl 5 and sealed to form a leak proof assembly. The non-return exhaust valve 7 acts as a pressure relief valve to prevent over pressurisation within the flexible cowl 5. The non-return exhaust valve 7 itself comprises non-return valves in series so as to prevent any reverse flow of gases back into the flexible cowl 5.

When the integrated respirator 1 is correctly mounted on the head, the oxygen mask suspension system 3 determines the viewing aperture located between the oxygen mask 3 and the brow of the inner helmet 2. This viewing aperture, and in particular the vertical distance, varies from subject to subject. Therefore, to accommodate these variations, with a minimum number of visor sizes, an adjustable means 26 of fitting the first visor 6 to the flexible cowl has been developed.

FIG. 6(a) presents detail of the adjustable means 26 that is characterised in that it is larger in the vertical dimension, than the viewing aperture provided. A space under the brow of the inner helmet 2 is produced by foreshortening the energy absorbing liner 14. Therefore, when the first visor 6 is too large for the aperture the top of the first visor 6 is inserted into the space underneath the inner helmet 2 as shown. The upper area of the flexible cowl 5 has sufficient material to allow the first visor 6 to move into the space underneath the inner helmet 2. Similarly sufficient material is provided between the oxygen mask suspension system and the first visor 6 so as to set the distance between the eyes and the inner surface of the first visor 6. To hold the first visor 6 in the optimum position it can be attached directly to the inner helmet 2 by, for example, draw strings or retaining clips that engage with

A further advantage of incorporating the visor adjustment means 26 within the integrated respirator 1 can be seen in FIG. 6(b). When donning the integrated respirator 1 the excess material of the flexible cowl 5 around the first visor 6 and the oxygen mask suspension system 3 permits both of these elements to be displaced to a position suitable for aiding the donning and doffing of the integrated respirator 1.

An alternative adjustment means 27 that also provides a method of accommodating the variations in vertical height between the oxygen mask suspension system 3 and the inner helmet 2 is shown in FIG. 7. In this case, the flexible cowl material that attaches the first visor 6 to the brow and side apertures of the inner helmet 2, allows for fore and aft adjustment. As such the lower portion of the first visor 6 can sit over the oxygen mask suspension system 3.

To assemble the integrated respirator 1, the flexible cowl 5, with integral visor 6 and oxygen mask suspension system 3, is pulled over the inner helmet 2. Location points can be provided on the inner helmet 2 to ensure that the flexible cowl 5 is correctly positioned. This ensures the respirator components, such as the visor 6 and oxygen mask suspension system 3, are correctly positioned. The overlap area between the inner helmet 2 and the flexible cowl 5 is bonded to ensure a leak tight seal preventing any ingress of agents when there is a negative pressure inside the visor 6 or inner helmet 2.

The flexible cowl 5 and inner helmet 2 assembly when donned, is not in contact with the user's head but contacts the user at the neck seal 25 area. This configuration prevents unacceptable levels of discomfort when wearing the NBC head protection.

By employing the aforementioned adjustment means, 26 or 27, provides that one particular flexible cowl 5 can be used in conjunction with a number of inner helmets 2 of varying dimensions. This factor increases the compatibility of employing the same design of integrated respirator 1 with different users while allowing minor adjustments to increase user comfort.

Additional protection for the flexible cowl from penetration by debris during and after ejection from an aircraft may also be achieved by incorporating a hood (not shown) that is attached to the lower edge of the inner helmet so as to envelope the flexible cowl. Such a hood provides further fire proof, snag proof and windblast proof properties to the integrated respirator.

One method of fabricating the integrated respirator 1 is to vacuum form the developed shape of the flexible cowl 5 from a sheet of NBC resistant flexible material as shown in FIG. 8. The flexible cowl 5 is formed by seam welding to produce a leak-tight joint 28. Thereafter, the oxygen mask suspension system 29 and visor apertures 30 are cut out of the flexible cowl.

The visor 6 is then injection moulded, for example from polycarbonate to a high optical quality and coated with a NBC resistant coating on the outside surface and with an anti fogging coating, if required, on the inside. Bonding areas of the visor 6 and the flexible cowl 5 are then prepared and the visor coating can, if required, be stripped off to provide a suitable bonding surface. The visor 6 can then be bonded to the flexible cowl 5 using a suitable adhesive.

In a similar manner the oxygen mask suspension assembly 3 is located within the appropriate aperture 29 and bonded with the flexible cowl 5 so as to produce the required leak tight seal. This may be achieved by the flexible cowl 5 being either fitted over or under the oxygen mask suspension assembly 3.

The neck seal 25 is also formed from a flexible NBC resistant material and bonded to the flexible cowl 5 to provide the required leak-tight seal at the neck area of the user.

An alternative embodiment of the integrated respirator 1 is shown in FIG. 9. In this embodiment the flexible cowl 5 comprises a detachable front section 31. Located on the front section 31 are the first visor 6 and the oxygen mask suspension system 3. Therefore, the detachable front section 31 allows for the removal of the first visor 6 and oxygen mask suspension assembly 3 if access is required in, for example, an emergency where the inspiratory 18 or expiratory valves 19 and 20 have jammed or the demist air supply 4 has failed.

The detachable front section 31 is attached and detached by means of an airtight seal 32, detail of which are provided in FIG. 10. The airtight seal 32 comprises a beaded edge 33 formed on the front section 31 and a channel 34 that matches the shape of the beading 33, formed on the flexible cowl 5. A zip 35 operating in zip guides 36 formed in the flexible cowl 5 and the front section 31 pull the front section beaded edge 33 into the channel 34 in the flexible cowl 5 thus forming a leak proof seal, as required.

A further alternative embodiment of the integrated respirator is shown in FIG. 11. Here the flexible cowl 5 is formed by vacuum forming and fabricating a hood from a material that will stretch sufficiently to allow the neck seal 25 to pass over the inner helmet 2. The oxygen mask suspension system 3 and the first visor 6 are then fitted as described above.

Access to the inner to outer helmet fixing points 13 is achieved by means of apertures 37 provided in the flexible cowl 5. Sealing of the flexible cowl 5 to the inner helmet 2 can be achieved by means of compression seals 38. The compression seals 38, attached to the flexible cowl 5, are compressed against the inner helmet 2 when the outer helmet 8 is placed on the user's head by the presence of the outer to inner helmet attachment points 10.

A yet further alternative embodiment of the integrated respirator is shown in FIG. 12. In this particular embodiment the flexible cowl 5 consists of two parts. The first part comprises a head cowl 39 that fits over the inner helmet 2 while the second comprises a detachable lower portion 40 that protects the neck and shoulder area. The lower portion 40 can be formed from a flexible material that provides increased mobility for the user. The two parts are held together by a leak proof joint 41 that is similar to that described in FIG. 10. The head cowl 39 can be manufactured to conform the shape of the inner helmet 2. As the lower portion contains the neck seal 25, this is the only component that is required to stretch over the head during fitting.

The integrated respirators shown in FIGS. 11 and 12 may be further adapted, so as to incorporate retractable earphones 42 as presented in FIG. 13. Each earphone 15 is mounted on the flexible respirator by means of Velcro®. A leaf spring 43 mounted on the inner surface of the inner helmet 2, biases the earphone 15 (or foam padding) in a first position as shown in FIG. 13(a). When a user pulls on a draw string 44, attached to the leaf spring 43, the bias force is overcome and the earphone 15 (or foam padding) is moved to a second, retracted position, as shown in FIG. 13(b). The earphone 15 can be fixed in the retracted position by securing the draw string to a an attachment means (not shown). The attachment means can be in the form of Velcro®, a stud fastener, a hook or any other suitable means. On releasing the draw string 44 from the attachment means the bias force of the leaf spring 43 acts to return the earphone 15 back to the first position. A compressible foam liner (not shown) may also be located between the leaf spring 43 and the inner helmet 2 so as to aid in the positioning of the earphone 15.

The retractable earphones 42 provide a means for allowing the earphones 15 to be easily displaced thus aiding the donning and doffing of the integrated respirator. This is particularly advantageous for user's who require the use of spectacles as the retractable earphones 42 allow the integrated respirator to be employed without dislodging the spectacles from the user.

In a further embodiment, shown in FIG. 14, an alternative design for the incorporation of the oxygen mask 3 and the flexible cowl 5 is presented. In this embodiment the flexible cowl 5 generally envelopes the oxygen mask 3. The required sealing of the oxygen mask is achieved by clamping the various components of the oxygen mask to the face seal 17 via a number of apertures created in the flexible cowl 5 e.g. an inspiratory valve aperture 45, an expiratory valve 46 aperture, a communication cables aperture 47 and a drinking tube 48 aperture. The number of apertures created in the flexible cowl will obviously be dependent on the particular design of the oxygen mask to be employed.

The integrated respirator described in aspects of the present invention exhibits several key advantages over those described in the Prior Art.

When deployed by a user the integrated respirator provides a significantly high level of comfort and user acceptability since it is designed to avoid direct contact with the user's head. The integrated respirators thereby provide space for head cooling while simultaneously help to eliminate the feeling of claustrophobia and stress that are known to result from respirator hoods that fit closely over the wearer's head. Further embodiments of the present invention incorporate an adjustable visor and retractable earphones both being features that aid in the donning and doffing of the respirator.

The integrated respirator designs describe above incorporate a certain degree of inherent flexibility. This flexibility allows the integrated respirators to be adjusted so as to improve user comfort while also permitting the same design to be employed by different users. In addition the present design reduces any alignment problems experienced by designs discussed in the Prior Art.

A further advantage of the integrated respirators described herein is that they can be simply manufactured. This manufacturing process is flexible and so enables the use of the most appropriate materials for NBC protection, user acceptability and ease of manufacture.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention herein intended.

1. An integrated respirator that provides an airtight barrier for a user's head comprising a first rigid helmet and a flexible cowl having an airtight neck seal, wherein the first rigid helmet defines an access aperture suitable for locating directly on a user's head and the flexible cowl is sealably fixed to the first rigid helmet so providing a physical barrier for the access aperture while forming an airtight seal with a user's neck.

2. An integrated respirator as claimed in claim 1 wherein the first rigid helmet and the flexible cowl comprise a material that protects against nuclear, chemical and biological hazards.

3. An integrated respirator as claimed in claim 1 or claim 2 wherein the flexible cowl completely encloses the first rigid helmet.

4. An integrated respirator as claimed in claim 1 or claim 2 wherein the flexible cowl is connected to the periphery of the access aperture.

5. An integrated respirator as claimed in claim 1 or claim 2 wherein the flexible cowl connects to an inner surface of the first rigid helmet.

6. An integrated respirator as claimed in claim 1 wherein the first rigid helmet provides a tight fit with the user's head.

7. An integrated respirator as claimed in claim 1 wherein the integrated respirator further comprises a hood that is fixed to the first rigid helmet so providing a physical barrier for the flexible cowl thus improving the fire proof, snag proof and windblast proof properties of the integrated respirator.

8. An integrated respirator as claimed in claim 1 wherein the flexible cowl comprises a visor aperture, an oxygen mask location area, a visor mist air supply and a pressure release valve.

9. An integrated respirator as claimed in claim 1 wherein the integrated respirator further comprises a second rigid helmet suitable for locating over the first rigid helmet.

10. An integrated respirator as claimed in claim 1 wherein the integrated respirator further comprises an oxygen mask and a first visor.

11. An integrated respirator as claimed claim 8 wherein the oxygen mask location area comprises a plurality of apertures suitable for receiving one or more component parts of the oxygen mask when the oxygen mask is located within the oxygen mask location area.

12. An integrated respirator as claimed claim 8 wherein the oxygen mask location area comprises a single aperture suitable for receiving the oxygen mask.

13. An integrated respirator as claimed claim 10 wherein the oxygen mask comprises a coating that provides a barrier for nuclear, biological and chemical hazards.

14. An integrated respirator as claimed claim 10 the oxygen mask provides an air tight seal about the user's nose and mouth.

15. An integrated respirator as claimed in claim 1 wherein the flexible cowl further comprises a detachable front face connected to the flexible cowl by a first airtight seal.

16. An integrated respirator as claimed in claim 15 wherein the first airtight seal comprises a beading edge associated with the detachable front face, a channel associated with the flexible cowl and suitable for receiving the beading edge and a zip mechanism suitable for opening and sealing the first airtight seal.

17. An integrated respirator as claimed in claim 1 wherein the flexible cowl comprises attachment point access holes and compression seals.

18. An integrated respirator as claimed in claim 1 wherein the flexible cowl further comprises a head cowl and a detachable lower section the head cowl and detachable lower section being connected by a second airtight seal.

19. An integrated respirator as claimed in claim 17 wherein the second airtight seal comprises a beading edge associated with the head cowl, a channel associated with the detachable lower section and suitable for receiving the beading edge and a zip mechanism suitable for opening and sealing the second airtight seal.

20. An integrated respirator as claimed in claim 17 wherein the first rigid helmet further comprises an energy absorbing liner, attachment points suitable for threading through the attachment point access holes such that the first rigid helmet can be connected to the second rigid helmet.

21. An integrated respirator as claimed in claim 1 wherein the first rigid helmet further comprises ear phones and at least one earphone aperture associated with each earphone.

22. An integrated respirator as claimed in claim 10 wherein the first rigid helmet further comprises attachment means suitable for connecting oxygen mask mounting means of the oxygen mask to the first rigid helmet.

23. An integrated respirator as claimed in claim 21 wherein the first rigid helmet comprises a retractable earphone mount wherein the retractable earphone mount comprises a bias means that acts to maintain an associated earphone in a first position and a retracting means suitable for overcoming the bias means such that the associated earphone is moved to a second retracted position suitable for aiding the donning and doffing of the integrated respirator.

24. An integrated respirator as claimed in claim 23 wherein the retracting means comprises a draw string threaded through an aperture in the first rigid helmet.

25. An integrated respirator as claimed in claim 24 wherein the first rigid helmet further comprises a securing means to which the draw string can be attached so as to maintain the retractable earphone mount in the second retracted position.

26. An integrated respirator as claimed in claim 10 wherein the first visor locates within the first visor aperture so providing a visor airtight seal with the flexible cowl.

27. An integrated respirator as claimed in claim 26 wherein the visor airtight seal provides means for adjusting the position of the first visor relative to the first rigid helmet.

28. An integrated respirator as claimed in claim 27 wherein the means for adjustment allows the visor to move to a displaced position suitable for aiding the donning and doffing of the integrated respirator.

29. An integrated respirator as claimed in claim 9 wherein the second rigid helmet further comprises a second visor.

30. An integrated respirator as claimed in claim 29 wherein the first and second visors comprise a high optical quality material that provides a barrier for nuclear, biological and chemical hazards.

31. A method of fabricating an integrated respirator comprising the steps of:
1) Fabricating a flexible cowl;
2) Forming an oxygen mask location area and a visor aperture in the flexible cowl;
3) Locating a visor within the visor aperture so as to form an airtight seal between the visor and the flexible cowl;
4) Locating an oxygen mask within the oxygen mask suspension system aperture so as to form an airtight seal between the oxygen mask and the flexible cowl; and
5) Attaching the flexible cowl to a first rigid helmet so as to form an airtight seal between the first rigid helmet and the flexible cowl.

32. A method of fabricating an integrated respirator as claimed in claim 31 wherein location points on the helmet ensure that the flexible cowl is correctly located on the first rigid helmet and provide means for connecting the first rigid helmet to a second rigid helmet.

33. A method of fabricating an integrated respirator as claimed in claim 31 wherein the step of fabricating the flexible cowl further comprises the steps of:
1) Vacuum forming a flexible material and fixing the vacuum formed material by seam welding; and
2) Fabricating an airtight neck seal and attaching said neck seal to the vacuum formed material;

34. A method of fabricating an integrated respirator as claimed in claim 33 wherein the step of fabricating the flexible cowl further comprises the steps of:
1) Connecting a visor mist air supply to the vacuum formed material; and
2) Connecting a pressure release valve to the vacuum formed material.

35. A method of fabricating an integrated respirator as claimed in claim 31 wherein the step of locating the visor further comprises the step of injection moulding the visor from a material of high optical coating.

36. A method of fabricating an integrated respirator as claimed in claim 31 wherein the step of locating the visor further comprises the step of coating the outer surface of the visor with a nuclear, biological and chemical resistant coating.

37. A method of fabricating an integrated respirator as claimed in claim 31 wherein the step of locating the visor further comprises the steps of coating the inner surface of the visor with an anti fogging coating.
